(19) United States
(12) Patent Application Publication
(10) Pub. No.: US 2016/0260545 A1
(43) Pub. Date: Sep. 8, 2016

(54) MULTI-LAYER DIELECTRIC FILM WITH NANOSTRUCTURED BLOCK COPOLYMER

(71) Applicant: COOPER TECHNOLOGIES COMPANY, Houston, TX (US)

(72) Inventors: Shireesh Pankaj, PUNE (IN); JAVED ABDURRAZZAQ MAPKAR, TOLEDO, OH (US); CHAO LI, FRANKLIN, WI (US); STEPHEN JOHN RIGBY, RACINE, WI (US)

(73) Assignee: COOPER TECHNOLOGIES COMPANY, Houston, TX (US)

(21) Appl. No.: 15/057,352

(22) Filed: Mar. 1, 2016

Related U.S. Application Data
(60) Provisional application No. 62/127,045, filed on Mar. 2, 2015.

(51) Int. Cl. H01G 4/18

(52) U.S. Cl. CPC H01G 4/186

(57) ABSTRACT

The disclosed concept relates to multi-layer dielectric film with nano- or micro-structured block copolymers, such as, but not limited to, di-block copolymers and tri-block copolymers, and, more particularly, to capacitors constructed from the film. More particularly, the disclosed concept provides the ability to tune or control one or more characteristics of the dielectric film and capacitors formed therefrom, by selecting and combining blocks that exhibit different electrical and/or mechanical properties.

### CROSS-REFERENCE TO RELATED APPLICATIONS

This application claims priority under 35 U.S.C. §119(e) to U.S. Provisional Patent Application Ser. No. 62/127,045, filed Mar. 2, 2015, entitled “Multi-Layer Dielectric Film with Nanostructured Block Copolymer”, which is herein incorporated by reference.

### BACKGROUND

1. Field

The disclosed concept relates generally to multi-layer dielectric films with nano- or micro-structured block copolymers and, more particularly, to capacitors constructed therefrom. The disclosed concept also relates to methods for preparing the films and the capacitors.

2. Background Information

Nanotechnology is an increasingly employed concept in the development and progression of a wide variety of technologies, including the field of electrochemistry. Nano-size and micro-size materials have been investigated and discovered for use in energy storage and conversion devices, such as, capacitors. Capacitors are used to store energy electrostatically under the application of an electric field. Conventional capacitors include two metallic plates or sheets separated by a dielectric material or sheet. The metal sheets and dielectric sheet can be stacked to form alternating layers. The efficiency of the capacitor typically depends on the selection of the dielectric material, the layer arrangement, the interfaces between the dielectric material and the metal plate or sheet, and the temperature.

FIG. 1 shows a conventional capacitor 1 in accordance with the prior art, that includes a metal cap 2, a wire 3, and alternating films of dielectric 5 and metal 7 in a rolled configuration. The number of alternating films of dielectric 5 and metal 7 can vary, and may include two layers of dielectric 5 and two sheets of metal 7, as shown in FIG. 1. A dielectric material, which is known in the art, is a single polymer, such as, polypropylene. The dielectric 5 is composed of a single polymer and therefore, the performance of the resulting capacitor 1 is typically dictated by the properties and orientation of the single polymer, for example, biaxially oriented polypropylene (BOPP).

The capacitor 1 can be formed using traditional manufacturing techniques known in the art. For example, it is known to extrude polypropylene film, stack the polypropylene film with metal sheets, and form the stack into a rolled configuration to provide a rolled-up capacitor.

There is a need in the art for capacitors with improved properties and thus, there is a need for dielectrics with improved properties, such as, but not limited to, high dielectric strength. It would be advantageous for a dielectric to exhibit high strength in addition to other desirable properties, such as, but not limited to, high dielectric permittivity. For example, polypropylene is known for use as a dielectric because it has a high breakdown strength. However, polypropylene has a dielectric constant of only 2.2 and therefore, there are limits as to how much energy can be stored. In contrast, polyvinylidene fluoride (PVDF) has a high dielectric constant, e.g., greater than 15, and can store significant energy but, has poor dielectric strength and therefore, cannot be used for high voltage application. It would be advantageous for a capacitor to be capable of storing significant energy while being capable of use in high voltage applications. Thus, there is room for improvement in dielectric materials and capacitors formed therefrom.

### SUMMARY

There exists a need for new dielectrics and this need and others are met by embodiments of the disclosed concept that are directed to multi-layer dielectric films including nano- and micro-structured block copolymers capable of providing combinations of properties, such as, high dielectric strength, high temperature, chemical resistance and high dielectric constant, for improved capacitor performance.

In one aspect, the disclosed concept provides a dielectric film, which includes a block copolymer having at least two different blocks. In certain embodiments, the block copolymer can be a di-block copolymer or a tri-block copolymer. Each of the at least two different blocks self-assemble to phase separated nano structures. The block copolymer can phase separate to form lamellae, cylindrical, spherical or gyroidal structures. Each of the two different blocks is selected based on its properties. In certain embodiments, one block may be selected because it exhibits high dielectric breakdown strength, and the other block may be selected because it exhibits high temperature electrical strength or high permittivity. Each of the two different blocks can be selected from a wide variety of polymers, including polypropylene, polyvinylidene fluoride, polyetheretherketone, and polyphenylene sulfide.

In certain embodiments, the dielectric film further includes filler selected from nanofillers and micro-fillers. The filler can include organic nanofillers, inorganic nanofillers, organic micro-fillers, inorganic micro-fillers, and mixtures thereof In certain embodiments, the filler can be selected from, for example, but not limited to, carbon nanotubes, graphene, silica, alumina, titanate and mixtures thereof. The titanate can be selected from titanium dioxide, barium titanate, and mixtures thereof.

Each of the at least two different blocks can be selected based on its ability to exhibit a desired property. In certain embodiments, one block can exhibit high dielectric breakdown strength and another block can exhibit high temperature electrical strength. In other embodiments, one of the at least two different blocks can exhibit high dielectric breakdown strength and the other block can exhibit high permittivity. In still other embodiments, one of the at least two different blocks can exhibit high dielectric breakdown strength, another block can exhibit high temperature electrical strength and another block can exhibit high permittivity. Further, wherein a filler, selected from nanofillers and micro-fillers, is present, the dielectric film can exhibit one or more of high dielectric breakdown strength, high temperature electrical strength, high permittivity and high dielectric constant.

In another aspect, the disclosed concept provides a method of preparing a film capacitor. The method includes obtaining a block copolymer having at least two different blocks, allowing the at least two different blocks to self-assemble forming alternating layers in a thin film dielectric, and rolling the thin film dielectric and a metal layer forming a capacitor in a rolled-up configuration.

Obtaining the block copolymer can include combining and polymerizing block copolymer precursors and filler.

Selecting the block copolymer precursors can be based on their properties and can include selecting one block copolymer precursor exhibiting high dielectric breakdown strength and selecting another block copolymer precursor exhibiting high temperature electrical strength or high permittivity.

The combining step can include combining the filler with one block to form a filler/block material and mixing the filler/block material with another block.

The method can further include locally dispersing the filler in the dielectric, wherein the filler can have a micro/molecular structure selected from spherical, tubular and layered.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic showing a conventional capacitor, in accordance with the prior art;

FIG. 2 is an illustration of various block-copolymer morphologies and structures, in accordance with the prior art;

FIG. 3 is a schematic showing a conventional extrusion apparatus, in accordance with the prior art;

FIG. 4 is a photograph of a roll of nanostructured block copolymer film, in accordance with certain embodiments of the disclosed concept;

FIG. 5 is a photograph showing a capacitor in a rolled configuration, in accordance with certain embodiments of the disclosed concept; and

FIG. 6 is a schematic showing alternating layers of nanostructured block copolymer and metal film, in accordance with certain embodiments of the disclosed concept.

### DESCRIPTION OF THE PREFERRED EMBODIMENTS

The disclosed concept relates to multi-layer dielectric films with nano- or micro-structured block copolymer. Further, the disclosed concept includes capacitors that are constructed with the multi-layer dielectric films. The disclosed concept is also directed to methods of preparing the dielectric films and the capacitors.

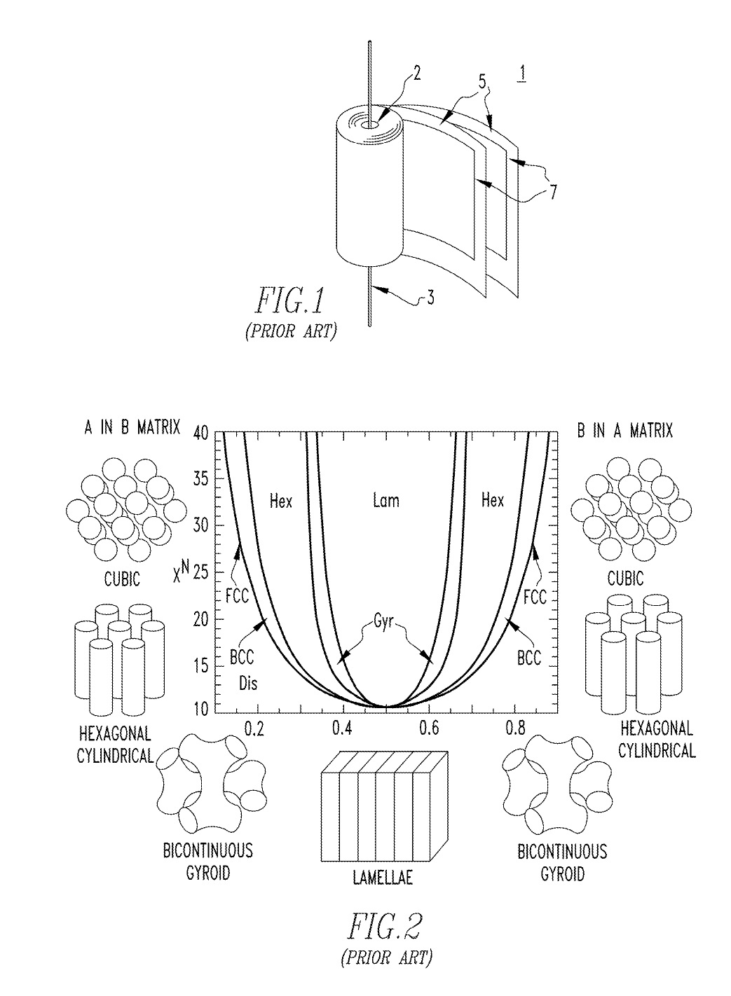

The multi-layer dielectric films in accordance with the disclosed concept include block copolymers having at least two different blocks. In certain embodiments, the block copolymers are di-block copolymers or tri-block copolymers. Block copolymers generally have the ability to phase separate and self-assemble. The self-assembly is thermodynamically-driven and, unlike monomers, block copolymers have a tendency to separate from each other. The mechanism of self-assembly can be described as being the result of competition between entropic and enthalpic contributions. The block copolymers can self-assemble into various morphologies or structures. FIG. 2 is a schematic illustrating such morphologies or structures. As shown in FIG. 2, block copolymer can self-assemble into structures including layered, cylindrical, gyroidal and spherical. The particular structure can depend on the volume fraction and block copolymer interaction parameters. Further, a block copolymer can provide a defect-free interface between two polymers, which also increases the inherent charge carrying capacity of a system.

In certain embodiments, the block copolymer employed in the disclosed concept self-assembles into a thin film. In the embodiment of a di-block copolymer, the thin film includes alternating layers of each block. For example, wherein the di-block copolymer has block A and block B, it self-assembles into a thin film, e.g., of thickness of the order of few tens of nanometers, having alternating layers of block A and block B. Further, in other embodiments, the thin film may include a plurality of layers of block A alternating with a plurality of layers of block B or a plurality of layers of block A alternating with a single layer of block B. Furthermore, in the embodiment of a tri-block copolymer, the thin film can include various configurations of alternating layers of block A, block B and block C.

The thin film can be employed as the dielectric material in forming a capacitor. Various capacitors are known in the art. In one embodiment, the thin film is rolled to form a rolled-up capacitor.

The blocks that form the block copolymer can each have different mechanical and/or electrical properties. In certain embodiments, the block copolymer is prepared by combining precursors, e.g., monomers, and polymerizing the precursors to form the block copolymer. Each of the blocks, e.g., monomers from which the blocks are derived, may be selected based on their particular properties and strengths. For example, a di-block copolymer can include one block selected because it demonstrates high dielectric strength and another block selected because it demonstrates high dielectric permittivity, although it also demonstrates low dielectric strength. Thus, the combination of these two blocks can provide a dielectric that exhibits both high dielectric strength and high dielectric permittivity.

In certain embodiments, each block may be selected because it exhibits more than one desired property or strength, such that the resulting block copolymer provides a dielectric having three or more desired properties or strengths. In other embodiments, the block copolymer can be prepared by combining more than two blocks. For example, the block copolymer can include tri-block copolymers with desired combination of properties from each of the three blocks, selected because of an unique desired property or strength demonstrated.

In accordance with the disclosed concept, block copolymer having at least two different blocks with different properties is used to impart various properties to dielectric material and ultimately, to the capacitor formed with the dielectric. Further, by selecting and combining particular blocks, and by specifying the segmental or monomer feed ratios, e.g., amounts, of the blocks, the disclosed concept provides the ability to tune or control the properties of the dielectric material and the resulting capacitor.

In one embodiment, selection of each of the blocks of the block copolymer can depend on the frequency dependence of the permittivity of the polymers, such that the capacitor's properties may be tuned for specific characteristic frequency.

In another embodiment, by employing one block that forms a layer with lower glass transition than a layer formed by another block, permittivity can be reversibly reduced by increasing the temperature to glass transition and, increased by cooling to glassy state.

Furthermore, for example, there can be the introduction of polar groups in one block and the other block being neutral, which provides for shielding in each layer and every layer.

In addition to selecting and combining particular blocks for the block copolymer in order to tune or control resulting properties, the amount of each of the blocks may also be specified in order to achieve desired properties in a dielectric material and resulting capacitor.

Suitable blocks for the block copolymers in accordance with the disclosed concept can be selected from those that are known in the art. As mentioned herein, the block copolymers can be synthesized from known monomers using any polymerization techniques or can be selected from those block copolymers, e.g., di-block or tri-block copolymer, that are commercially available.

In certain embodiments, a filler can be combined with the block copolymer in preparing the dielectric material. The filler can include organic nanofillers, inorganic nanofillers, organic micro-fillers, inorganic micro-fillers, and mixtures thereof. In general, filler has an affinity to a particular polymer or block in a block copolymer. When the block copolymer is synthesized using monomer, the filler can be combined with the monomer and then polymerized. Various fillers are known in the art and these known materials are suitable for use in the disclosed concept. Non-limiting examples include carbon nanotubes, graphene, silica, alumina, titanate, such as, but not limited to, titanium dioxide, barium titatnate and mixtures thereof. Titanium dioxide and barium titatnate are known to increase the dielectric constant and, silica and alumina are known to increase dielectric strength and partial discharge resistance.

Thus, on an as-needed basis for various applications, filler can be combined with the blocks of the block copolymer to achieve a dielectric film with high dielectric constant (exhibited by the titanate nanofiller), high dielectric strength (demonstrated by one block) and high dielectric permittivity (demonstrated by another block), to design a high energy density capacitor.

The amount of filler used and its ratio to monomer, e.g., blocks of the di-block copolymer, can vary and may depend on the particular filler and monomers, e.g., blocks, selected.

The filler can be preferably in one phase depending on the interaction and polarity, as well as, the availability of free volume/excluded volume. As a result, the charge storage of a resulting capacitor may be improved.

Further, the disclosed concept includes the ability to control the structure or shape that the filler forms inside the film. By controlling the ratio between monomers/blocks A and B, one of the monomers/block, e.g., monomer/block A, may be spherical, tubular or in a film phase in monomer/block B, or vice versa.

Furthermore, it is known in the art that a challenge associated with the use of filler is the ability to uniformly disperse the filler in a polymer matrix and achieve good distribution. In accordance with the block copolymer approach described herein, there is the ability to tailor the filler to uniformly disperse in one of the blocks, e.g., block A, and then mix the filled block A with block B in different ratios to form filler distribution as spherical, tubular or alternating layers with one filler-rich layer.

In general, the disclosed concept includes preparing and manufacturing layered capacitors and, in particular, capacitors in a rolled-up configuration. In accordance therewith, oriented nano- or micro-structures are created by selecting a block copolymer, e.g., di-block or tri-block copolymer, that can phase separate, and heating the block copolymer above the order-disorder transition. The resulting thin film is extruded and a preferred orientation is achieved in the machine direction. Orientation also can be achieved by means of any external field including, but not limited to, electrical, magnetic, thermal, shear and the like.

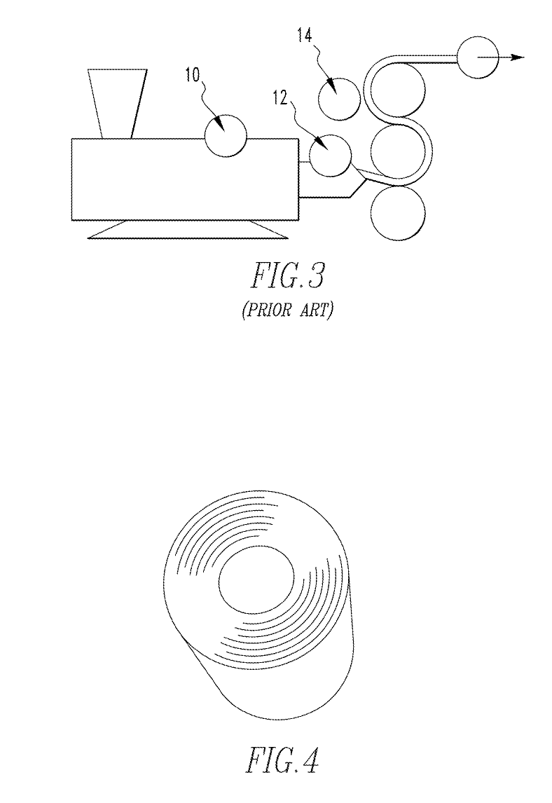

FIG. 3 shows a conventional extrusion apparatus for producing a roll of di-block copolymer film in accordance with certain embodiments of the disclosed concept. In general, extrusion is a high volume manufacturing process in which raw material is melted and formed into a continuous profile. FIG. 3 includes an extruder 10, film die 12 and roll calendar 14. The copolymer having blocks A and B are fed into the extruder 10. It is contemplated, in certain embodiments, that monomer, e.g., monomer A and monomer B, can be fed into the extruder. Further, in certain other embodiments, in addition to the monomer or blocks, the filler may be fed into the extruder. Each of the blocks A and B are present in a ratio of 1:1 and undergo extrusion using extruder 10 and conventional procedures, like calendaring, etc. At a particular temperature, e.g., order-disorder transition temperature, which can depend on the specific blocks A and B selected, the blocks A and B melt and phase separate.

In certain embodiments of the disclosed concept, the copolymer is a di-block co-polymer including blocks of polymer, such as, but not limited to, polypropylene and polyvinylidene fluoride (PVDF). As a result of extrusion and self-assembly of the polypropylene block and the PVDF block, there are formed separate alternating layers of polypropylene and PVDF blocks. The number and thickness of the layers can vary. Typically, the thickness of each layer can be about 25 nm. This alternating layer configuration is then formed into a thin film using the film die 12 shown in FIG. 3. The purpose of the die 12 is generally to reorient and guide the flow of polymer melt from a single round output from the extruder 10 to a thin, flat planar flow. Further, the die 12 insures constant, uniform flow across the cross-sectional area of the die 12.

The thickness of the thin film can also vary. It is conventional for a thin film to have a thickness from about 10 to about 15 microns. The thin film is cooled and wound into a roll. Cooling is typically accomplished by pulling through a set of cooling rolls, such as, by a chill roll or the roll calender 14 shown in FIG. 3. In sheet extrusion, the roll calender 14 not only delivers the necessary cooling but can be adapted to also determine sheet thickness and surface texture. The thin film then undergoes convection and further, one roll can be formed into multiple rolls by roll splitting.

In general, an alternating layer configuration formed in the melt and phase separation of blocks A and B is retained in the thin film configuration, which is subsequently formed. Thus, in certain embodiments, the resultant thin film can have from about 100 to about 1000 layers of alternating blocks A and B. For example, a single film of di-block copolymer can have thousands of alternating layers of the two polymers/blocks, e.g., each layer having a thickness of about 25 nm, with well-defined segregation. When the film is rolled, it is contemplated that millions of layers can be stacked. FIG. 4 shows a roll of film having about 1000 layers of alternating nanostructured blocks A and B.

The roll of the nanostructured block copolymer film serves as a dielectric material for a capacitor. The dielectric material is combined with at least one electrode layer. The electrode layer is not limited particularly, and is a layer generally made of a conductive metal such as, but not limited to, aluminum, zinc, gold, platinum or copper, and used in the form of a metal foil or a deposited metal film. In the disclosed concept, either a metal foil or a deposited metal film may be used or both may be used together. The capacitor can be formed by rolling a metal film in an alternating layer configuration with the dielectric film. While the description is directed to capacitors, it is contemplated and understood that the disclosed concept is not limited to only capacitors. The disclosed concept is generally applicable to various aspects and products of the electronics industry.

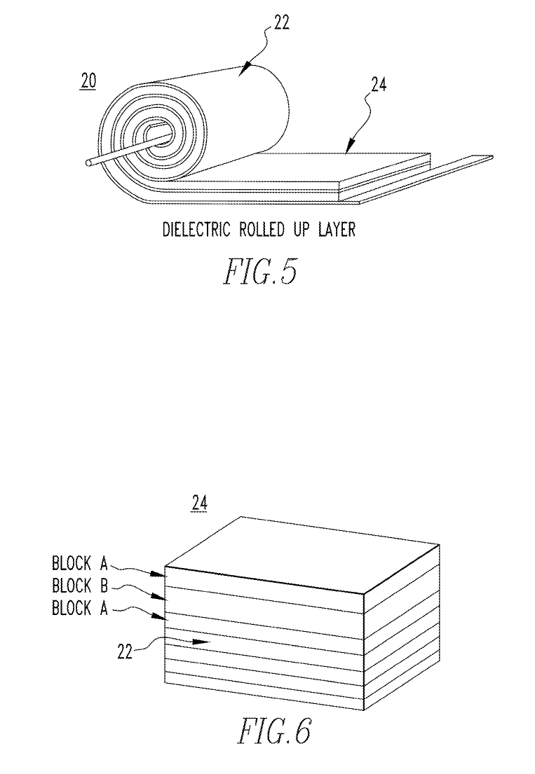

FIG. 5 shows a capacitor 20 formed by combining in a roll, a metal film 22 with a dielectric film 24. A detail of the dielectric film 24 is shown in FIG. 6. As shown in FIG. 6, the dielectric film 24 includes separate alternating layers of copolymers/blocks A and B and the metal film 22. Although, FIG. 6 shows only a single layer of metal film 22, it is contemplated that in accordance with the disclosed concept more than one metal film 22 can be used.

An advantage of the disclosed concept is the ability to provide capacitors that have a unique combination of properties, which can improve their performance in a variety of applications. Other advantages can include, but are not limited to, one or more of the following:
Ability to add filler in the polymer;
Ability to control selective phase of the filler in the film; and
Increased temperature capacity of the capacitor.

With respect to temperature capacity, known dielectric materials, such as polypropylene film, for use in conventional capacitors has a temperature limit of about 75° C. Therefore, dielectric materials, such as polypropylene film are not typically suitable for use in applications that require higher temperatures. Non-limiting examples of such applications include desert environments and defense applications. High temperature polymers such as polyetheretherketone (PEEK), polyphenylene sulfide (PPS) and the like, do not have high dielectric breakdown strength (as does polypropylene). Thus, these polymers, e.g., PEEK and PPS, are typically not used for high voltage applications. However, in accordance with the disclosed concept, the nanostructured block copolymer approach provides the ability to effectively design a dielectric film with block A having high dielectric strength (e.g., polypropylene) and block B (e.g., PEEK or PPS) having high temperature electrical strength, which can impart a combination of these properties to the resulting film capacitor including the dielectric and therefore, the film capacitor can be used for high temperature applications.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A dielectric film, comprising:
a block copolymer having at least two different blocks,
wherein each of the at least two different blocks self-assemble to form alternating layers within the dielectric film.

2. The dielectric film of claim 1, wherein each of the two different blocks is selected from different polymers, including but not limited to, polypropylene, polyvinylidene fluoride, polyetheretherketone and polyphenylene sulfide.

3. The dielectric film of claim 1, further comprising a filler selected from nanofiller, micro-filler and mixtures thereof.

4. The dielectric film of claim 3, wherein the filler comprises organic or inorganic nanofiller and micro-filler.

5. The dielectric film of claim 3, wherein the filler is selected from the group consisting of carbon nanotube, graphene, silica, alumina, titanate, and mixtures thereof.

6. The dielectric film of claim 5, wherein the titanate is selected from titanium dioxide, barium titatnate and mixtures thereof.

7. The dielectric film of claim 1, wherein each of the at least two different blocks is selected based on its ability to exhibit a desired property.

8. The dielectric film of claim 1, wherein one block exhibits high dielectric breakdown strength and another block exhibits high temperature electrical strength.

9. The dielectric film of claim 1, wherein one of the at least two different blocks exhibits high dielectric breakdown strength and the other block exhibits high permittivity.

10. The dielectric film of claim 1, wherein one of the at least two different blocks exhibits high dielectric breakdown strength, another block exhibits high temperature electrical strength and another block exhibits high permittivity.

11. The dielectric film of claim 6, wherein said dielectric exhibits one or more of high dielectric breakdown strength, high temperature electrical strength, high permittivity and high dielectric constant.

12. The dielectric film of claim 1, wherein each of the blocks is selected based on frequency dependence of permittivity of polymers, such that properties of a capacitor formed by the dielectric film is capable of being tuned for specific characteristic frequency.

13. The dielectric film of claim 1, wherein one block forms a layer with lower glass transition than a layer formed by another block, and permittivity being reversibly reduced by increasing temperature to glass transition and, increased by cooling to glassy state.

14. The dielectric film of claim 1, wherein of on block includes polar groups and another block is neutral, which provides for shielding in each layer of the dielectric film.

15. A method of preparing a film capacitor, comprising:
obtaining a block copolymer having at least two different blocks;
allowing the at least two different blocks to self-assemble forming alternating layers in a thin film dielectric; and
rolling the thin film dielectric and a metal layer forming a capacitor in a rolled-up configuration.

16. The method of claim 15, wherein obtaining a block copolymer, comprises:
selecting block copolymer precursors;
selecting filler;
combining said block copolymer precursors and said filler; and
polymerizing said block copolymer precursors and filler.

17. The method of claim 16, wherein the selecting the block copolymer precursors is based on their properties and includes selecting one block copolymer precursor exhibiting high dielectric breakdown strength and selecting the other block copolymer precursor exhibiting one of high temperature electrical strength and high permittivity.

18. The method of claim 16, wherein the combining step comprises combining said filler with one block forming a filler/block material and mixing the filler/block material with another block.

19. The method of claim 16, further comprising selecting and combining particular blocks for the block copolymer to tune or control properties of a capacitor formed by the dielectric material.

20. The method of claim 16, further comprising, specifying the amount of each of the blocks to achieve desired properties in the dielectric material and a resulting capacitor.
